(19) United States
(12) Patent Application Publication
(10) Pub. No.: US 2021/0224470 A1
(43) Pub. Date: Jul. 22, 2021

(54) METHOD AND DEVICE FOR PROCESSING STATIC PAGE DATA

(71) Applicants: BEIJING BOE OPTOELECTRONICS TECHNOLOGY CO., LTD., Beijing (CN); BOE TECHNOLOGY GROUP CO., LTD., Beijing (CN)

(72) Inventor: Peng LU, Beijing (CN)

(73) Assignees: BEIJING BOE OPTOELECTRONICS TECHNOLOGY CO., LTD., Beijing (CN); BOE TECHNOLOGY GROUP CO., LTD., Beijing (CN)

(21) Appl. No.: 16/306,795

(22) PCT Filed: Feb. 27, 2018
(86) PCT No.: PCT/CN2018/077407

§ 371 Date: Dec. 3, 2018

(30) Foreign Application Priority Data
Jul. 18, 2017 (CN) 201710587072.4

(51) Int. Cl. G06F 40/169; G06F 16/9538; G06F 16/958

(52) U.S. Cl. CPC G06F 40/169; G06F 16/986; G06F 16/9538

(57) ABSTRACT

Disclosed is a method for processing static page data, said method includes: receiving an asynchronous request message for comment data as initiated by a user equipment while requesting a static page; and searching for comment data corresponding to the static page in a storage module according to the asynchronous request message, and returning the comment data to the user equipment to be presented on the static page. A device for processing static page data is also disclosed. This solution enables users to view other people's comment information on the page and to comment on any static page.

### TECHNICAL FIELD

Embodiments of the present disclosure relate to, but not limited to, the technical field of network communication, and in particular, to method and device for processing static page data.

### BACKGROUND

Development of Internet technology has made it easier for people to interact information with each other, and web pages are a necessary way to obtain Internet information. In order to further improve convenience of information interaction among users, the comment function of websites becomes especially important, most web pages are dynamic pages, and the dynamic effect is achieved by compiling the pages by the server. Further, the comment function is one of the most important functions of a majority of dynamic websites. Comment data of the front-end users is stored by a back-end server, then pages are dynamically loaded by the server, so that contents of the comment are displayed on the front-end pages. As for static pages (static web pages actually exist, they are directly loaded and displayed on the client browser, without being compiled by the server), there is no dynamic loading module for the back-end server, most static pages provide only sharing of information (e.g., sharing of knowledge etc.), every page of static websites is directly returned from the server, and dynamic data update cannot be achieved, thus the comment function cannot be achieved with respect to the static pages per se.

### SUMMARY

The technical problem addressed by the embodiments of the present disclosure is to provide a method and device for processing static page data, so as to enable users to view other people's comment information on the page and to comment on any static page.

A method for processing static page data, comprising:
receiving a request message for accessing comment data of a static page from a user equipment; and
searching for comment data corresponding to the static page in a storage module according to the request message, and returning the comment data to the user equipment.

Optionally, the request message for accessing the comment data of the static page includes user information and a uniform resource locator of a current page being accessed.

Optionally, when returning the comment data to the user equipment, the method further comprises:
also returning a comment submitting module for receiving user comment.

Optionally, after returning the comment data to the user equipment, the method further comprises:
upon receipt of the user comment, performing data processing on the user comment and thereafter storing it in a local comment data file corresponding to the current page.

Optionally, after returning the comment data to the user equipment, the method further comprises:
upon receipt of the user comment, storing a correspondence relationship between the user comment after data processing and the current page into a local database.

A device for processing static page data, comprising:
a reception module configured to receive a request message for accessing comment data of a static page from a user equipment;
a storage module configured to store the comment data; and
a processing module configured to search for comment data corresponding to the static page in a storage module according to the request message, and return the comment data to the user equipment.

Optionally, the request message for accessing the comment data of the static page includes user information and a uniform resource locator of a current page being accessed.

Optionally, the device further comprises:
a comment submitting module configured to receive user comment, and output the user comment to the storage module;
the storage module is further configured to, after receiving the user comment, perform data processing on the user comment and thereafter store it in a local comment data file corresponding to the current page, or store a correspondence relationship between the user comment after data processing and the current page into a local database.

Optionally, the processing module is further configured to, when returning the comment data to the user equipment, also return a comment submitting module.

A device for processing static page data, comprising: a memory, a processor and a computer program stored on the memory and operable on the processor, wherein the processor, when executing the program, carries out the following steps:
receiving a request message for accessing comment data of a static page from a user equipment; and
searching for comment data corresponding to the static page in a storage module according to the request message, and returning the comment data to the user equipment.

To sum up, the embodiments of the present disclosure provide a method and device for processing static page data, so that users can comment on any static page and view other people's comment information on the page.

### BRIEF DESCRIPTION OF THE DRAWINGS

FIG. 1 is a flowchart of a method for processing static page data according to a first embodiment of the present disclosure;

FIG. 2 is a flowchart of a method for processing static page data according to a second embodiment of the present disclosure;

FIG. 3 is a flowchart of a method for processing static page data according to a third embodiment of the present disclosure;

FIG. 4 is a schematic diagram of a device for processing static page data according to a fourth embodiment of the present disclosure; and

FIG. 5 is a schematic diagram of a device for processing static page data according to a fifth embodiment of the present disclosure.

### DETAILED DESCRIPTION OF THE EMBODIMENTS

To make the objectives, the technical solutions, and the advantages of the present disclosure more clear, the embodiments of the present disclosure will be described in detail below with reference to the accompanying drawings. It needs to be noted that, in a case of having no conflict, the embodiments of the present disclosure and the features in the embodiments may be combined arbitrarily.

### First Embodiment

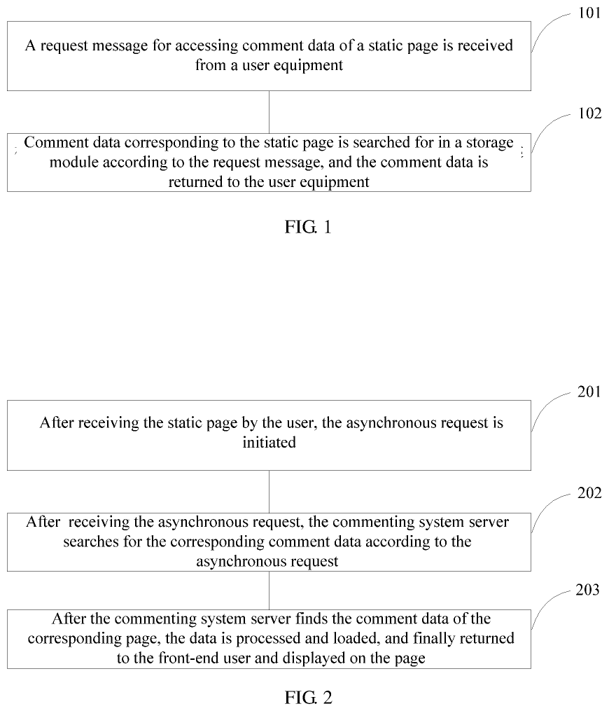

FIG. 1 is a flowchart of a method for processing static page data according to an embodiment of the present disclosure. As shown in FIG. 1, the method of this embodiment comprises the following steps:

Step 101, a request message for accessing comment data of a static page is received from a user equipment; and

Step 102, comment data corresponding to the static page is searched for in a storage module according to the request message, and the comment data is returned to the user equipment.

Herein, the request message for accessing the comment data of the static page includes user information and a Uniform/Universal Resource Locator, URL, of a current page being accessed.

This embodiment of the present disclosure solves the problem that static pages cannot be commented and dynamically loaded by constructing a separate commenting system. A segment of code is embedded in a static page, an asynchronous request instruction is initiated while the user requests the static page. After the instruction arrives at the commenting system, the stored comment data is obtained from the local file and finally presented on the front-end page.

Meanwhile, the comment submitting module may also be presented on the front-end page, and the user can post a comment on the comment submitting module. Similarly, the comment instruction is sent to the commenting system server in an asynchronous request manner, and the commenting system processes data of the comment instruction and saves it in the local file.

This process does not require dependency related to the client and the browser module, all users browsing the static page can achieve the comment function through asynchronous loading, and the commenting system is independent of the static website.

### Second Embodiment

FIG. 2 is a flowchart of a method for processing static page data according to an embodiment of the present disclosure. As shown in FIG. 2, the method of this embodiment comprises the following steps:

Step 201, after receiving the static page by the user, the asynchronous request is triggered. The static page is directly fed back to the front-end user browser without being compiled by the server. The front-end user browser triggers the asynchronous request after receiving the returned static page.

Content of the asynchronous request includes current user information and URL of the current page being accessed, and the asynchronous request is sent to the commenting system server.

In this embodiment, after the user accesses the static page, the asynchronous request is triggered, and the comment module and the corresponding comment data are obtained from the comment server. During processing of the comment server, the browser continues to load other elements of the static page without being affected by the blocking.

Step 202, after receiving the asynchronous request, the commenting system server searches for the corresponding comment data according to the asynchronous request.

After the commenting system server parses the asynchronous request and obtains user information and URL of the current page being accessed, the corresponding comment data is searched for in the storage module according to the user information and the URL of the current page being accessed.

Step 203, after the commenting system server finds the comment data of the corresponding page, the comment data is processed and loaded, and finally returned to the front-end user and presented on the page.

In this way, the method of this embodiment can implement asynchronous loading of local comment data.

### Third Embodiment

This embodiment differs from the second embodiment in: a comment submitting module is also returned to the user while the comment data is returned to the user equipment by the commenting system.

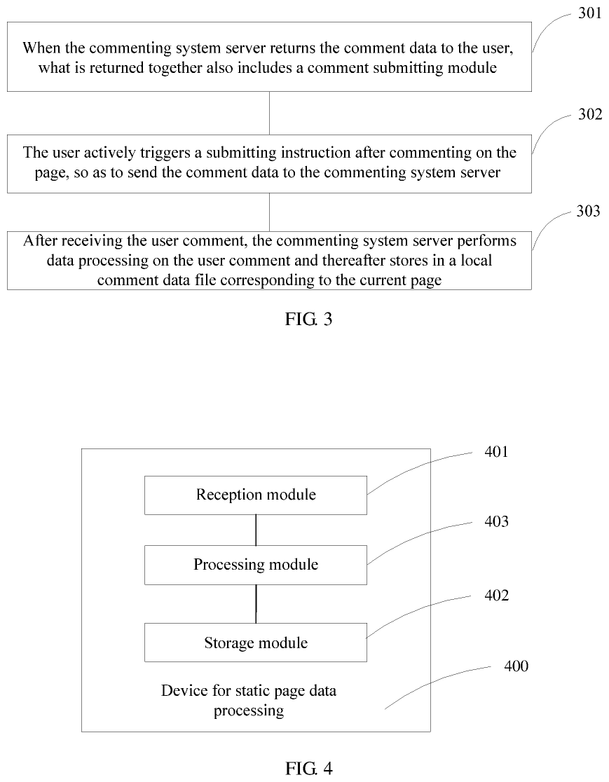

FIG. 3 is a flowchart of a method for processing static page data according to an embodiment of the present disclosure. As shown in FIG. 3, the method of this embodiment comprises the following steps.

Step 301, when the commenting system server returns the comment data to the user, what is returned together also includes a comment submitting module, and the user can comment on the page in the comment submitting module.

Step 302, the user actively triggers a submitting instruction after commenting on the page, so as to send the comment data to the commenting system server.

Step 303, after receiving the user comment, the commenting system server performs data processing on the user comment and thereafter stores it in a local comment data file corresponding to the current page.

In respect of storage of the comment data, a database module may be established in the commenting system server for storing the user comment data.

The advantages of establishing a database module in the commenting system server are that: data is stable and secure, and is not easy to be lost, but database service needs to be built, and resource consumption is large.

### Fourth Embodiment

FIG. 4 is a schematic diagram of a device for processing static page data according to an embodiment of the present disclosure. As shown in FIG. 4, the device 400 for processing static page data according to the present embodiment comprises:
a reception module 401 configured to receive a request message for accessing comment data of a static page from a user equipment;
a storage module 402 configured to store comment data; and
a processing module 403 configured to search for comment data corresponding to the static page in a storage module according to the request message, and return the comment data to the user equipment.

This embodiment of the present disclosure solves the problem that static pages cannot be commented and dynamically loaded, by constructing a separate commenting system which comprises the device 400 for processing static page data according to the present embodiment. In this embodiment, a segment of code is embedded in a static page, an asynchronous request instruction is initiated while the user requests the static page. After the instruction arrives at the commenting system server, the stored comment data is obtained from the local file and finally presented on the front-end page.

Herein, the request message for accessing the comment data of the static page includes user information and a URL of a current page being accessed.

In this way, the device of this embodiment can implement asynchronous loading of local comment data.

### Fifth Embodiment

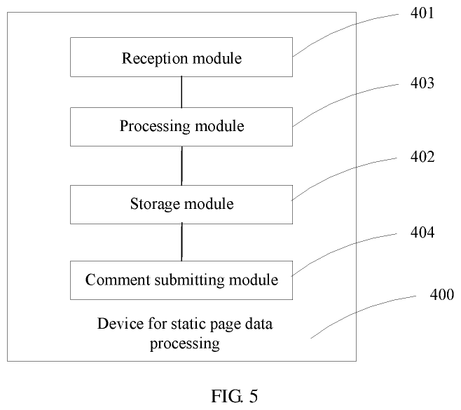

This embodiment differs from the fourth embodiment in: as shown in FIG. 5, the device 400 for processing static page data further comprises:
a comment submitting module 404 configured to receive user comment, and output the user comment to the storage module 402;
the storage module 402 is further configured to, after receiving the user comment, perform data processing on the user comment and thereafter store it in a local comment data file corresponding to the current page, or store a correspondence relationship between the user comment after data processing and the current page into a local database.

The processing module 403 may be further configured to when returning the comment data to the user equipment, also return a comment submitting module 404.

The device of this embodiment can realize comment submission on the static page.

This embodiment further provides a device for processing static page data, comprising: a memory, a processor and a computer program stored on the memory and operable on the processor, wherein the processor, when executing the program, carries out the following steps:
receiving a request message for accessing comment data of a static page from a user equipment; and
searching for comment data corresponding to the static page in a storage module according to the request message, and returning the comment data to the user equipment.

The technical solution of this embodiment of the present disclosure enables users to comment on any static page and to view other people's comment information on the page.

An embodiment of the present disclosure also provides a computer-readable storage medium storing computer-executable instructions that, when executed, implement the method for processing static page data.

As will be appreciated by those of ordinary skill in the art, all or parts of the steps in the above embodiments may be implemented by a program that instructs relevant hardware, the program may be stored in a computer-readable storage medium, such as a read-only memory, a magnetic disc, an optical disk, or the like. Optionally, all or parts of the steps of the above embodiments may also be implemented using one or more integrated circuits. Correspondingly, each module/unit in the foregoing embodiments may be implemented in form of hardware, or may be implemented in form of a software functional module. The present disclosure is not limited to any specific form of combination of hardware and software.

The foregoing are only preferred embodiments of the present disclosure, the present disclosure may of course have various other embodiments. Various corresponding changes and modifications may be made by those skilled in the art without departing from the spirit and scope of the present disclosure, but these corresponding changes and modifications should be within the protection scope of the appended claims of the present disclosure.

The present application claims the benefit of priority of Chinese patent application with the application No. of 201710587072.4, filed on Jul. 18, 2017, which is incorporated by reference herein in its entirety as a portion of the present application.

1. A method for processing static page data, comprising:
receiving an asynchronous request message for comment data as initiated by a user equipment while requesting a static page; and
searching for comment data corresponding to the static page in a storage module according to the asynchronous request message, and returning the comment data to the user equipment to be presented on the static page.

2. The method of claim 1, wherein
the request message for accessing the comment data of the static page includes user information and a Uniform Resource Locator of a current page being accessed.

3. The method of claim 1, wherein when returning the comment data to the user equipment, the method further comprises:
returning a comment submitting module for receiving user comment.

4. The method of claim 3, wherein after returning the comment data to the user equipment, the method further comprises:
upon receipt of the user comment, performing data processing on the user comment and storing the user comment in a local comment data file corresponding to the current page.

5. The method of claim 3, wherein after returning the comment data to the user equipment, the method further comprises:
upon receipt of the user comment, storing a correspondence relationship between the user comment after data processing and the current page into a local database.

6. A device for processing static page data, comprising:
a reception module configured to receive an asynchronous request message for comment data as initiated by a user equipment while requesting a static page;
a storage module configured to store comment data; and
a processing module configured to search for comment data corresponding to the static page in the storage module according to the asynchronous request message, and return the comment data to the user equipment to be presented on the static page.

7. The method of claim 6, wherein
the request message for accessing the comment data of the static page includes user information and a Uniform Resource Locator of a current page being accessed.

8. The method of claim 6, wherein the method further comprises:
a comment submitting module configured to receive user comment, and output the user comment to the storage module;
the storage module is further configured to, after receiving the user comment, perform data processing on the user comment and thereafter store it in a local comment data file corresponding to the current page, or store a correspondence relationship between the user comment after data processing and the current page into a local database.

9. The method of claim 8, wherein
the processing module is further configured to when returning the comment data to the user equipment, return the comment submitting module.

10. A device for processing static page data, comprising: a memory, a processor and a computer program stored on the memory and operable on the processor, wherein the processor, when executing the program, carries out the following steps:
receiving an asynchronous request message for comment data as initiated by a user equipment while requesting a static page; and
searching for comment data corresponding to the static page in a storage module according to the asynchronous request message, and returning the comment data to the user equipment to be presented on the static page.

11. The method of claim 2, wherein when returning the comment data to the user equipment, the method further comprises:
returning a comment submitting module for receiving user comment.

12. The method of claim 7, wherein the method further comprises:
a comment submitting module configured to receive user comment, and output the user comment to the storage module;
the storage module is further configured to, after receiving the user comment, perform data processing on the user comment and thereafter store it in a local comment data file corresponding to the current page, or store a correspondence relationship between the user comment after data processing and the current page into a local database.
